(19) United States
(12) Patent Application Publication
(10) Pub. No.: US 2010/0083811 A1
(43) Pub. Date: Apr. 8, 2010

(54) Training and performance percussion plectrum

(76) Inventor: Johnathan Lloyd Gsell, Gloucester, VA (US)

Correspondence Address: Johnathan L. Gsell, 4063 Rosewell Plantation Road, Gloucester, VA, 23061, US

(21) Appl. No.: 12/586,982

(22) Filed: Sep. 30, 2009

Related U.S. Application Data
(60) Provisional application No. 61/195,050, filed on Oct. 3, 2008.

(51) Int. Cl. G10D 3/16

(52) U.S. Cl. 84/322; 84/320

(57) ABSTRACT

A percussion plectrum provides a unique sound that is soft. It also aids in training a stringed instrument player in learning to pick the strings of the instrument. The plectrum is teardrop shaped and includes bristles having frayed ends which are uneven in length and spaced unevenly apart from one another. The plectrum may be held with a firmer grip without fear of losing it into the strings or producing a loud harsh tone that ordinarily is produced with a firm grip.

This is a continuation of provisional patent application No. 61/195,050 which was filed on Oct. 3, 2008 for John L. Gsell of Gloucester Va., USA.

The present application did not receive any federal research and/or development funding.

### TECHNICAL FIELD

Generally, the invention is an improved percussion plectrum for aiding a musician in learning to properly strum the strings of a musical instrument. The plectrum has two ends. One end is shaped with a pointed end for use in a live performance or by a seasoned musician. The other end is for use in producing a softer sound or use as an instructional device that teaches a novice musician how to properly strum the strings. Either side may be used in playing a stringed instrument during a training session or live performance. More particularly, the plectrum includes a grip portion, preferable held between the thumb and finger of the musician. The grip is teardrop shaped and having three edges defined by three ends. Two of the ends are rounded whilst the third is more pointed and for use in live performances. A plurality of frayed bristles extends from the edge defined by the rounded ends and opposite the pointed end. The rounded edges on either side of the frayed bristles are used during training sessions or live performances to strike the string harder without substantially increasing the volume of the instrument. Individual strands of each bristle are splayed out in a random fashion to give the pick a softer striking surface with which to engage the strings of the instrument. The individual strands attenuate the sound produced by the pick when the rounded edges are used.

### BACKGROUND OF THE INVENTION

Musicians typically use plectrums or picks to play stringed musical instruments, such as guitars, mandolins, and basses. Typically, these plectrums are oval or teardrop shaped. They are flat or planar for holding between a musician's thumb and finger, and made of resilient or non resilient materials in a wide variety of thicknesses.

There are many types of plectrums for a variety of stringed instruments. By way of example, some of these include U.S. Pat. No. 5,942,704 to Weldon which is a brush plectrum for stringed instruments. U.S. Pat. No. 6,133,516 to Hendrickson discloses an instrument pick with multiple pick members. U.S. Pat. No. 4,248,128 discloses a guitar pick array. U.S. Pat. No. 5,261,307 discloses a segmented musical pick. U.S. Pat. No. 6,342,661 discloses a multi-string guitar pick. U.S. Pat. No. 5,594,189 too Latteri discloses a tri-point plectrum for string instruments. U.S. Pat. No. 5,271,308 discloses a soft attack guitar pick. Some of these include a plurality of members of the same width. It should be noted that there is a distinct difference when placing a number of members that are all 0.05 mm thick onto a pick. The sound is very dull. On the other hand, placing a number of members that are all 0.5 mm thick produces a sound that is extremely heavy and overrides the sound produced by the pick.

Traditionally. the hardest thing for a new musician to accomplish while strumming a guitar is the “upstroke”. Striking the strings in a downward direction is simple since the musician can view the pick and how it impacts the strings. However, strumming the strings in an upward direction is a difficult motion to perfect and often causes the pick to become caught in the strings of the instrument. Moreover, learning to play a musical instrument may cause undue fatigue and pain to the musician's hand and wrist. The instant invention is a training aid that, when used, forces musician to assume the correct seamless upstroke motion while preventing the pick from being caught in the strings. When used, the device does not override the traditional sound created by strumming the string. Further, the invention reduces fatigue and stress on the player's hand and wrist.

### SUMMARY OF THE INVENTION

None of the aforementioned patents are training devices that force a musician's hand into a correct upward strumming motion without fear of catching the plectrum in the strings of the instrument. None of them include all of the unique features of the present invention. Moreover, none of the mentioned patents can achieve the unique sounds that can be created by the instant invention. Further, none of the art reduces fatigue of the player's wrist. An added benefit of using the invention is that the fingers used in producing the chords, do not have to press onto the frets as hard to achieve a desired sound. Thus, the instant device also reduces stress on the chord hand.

The instant invention is a plectrum that includes a grip portion preferably held between the thumb and forefinger by the musician. In the preferred embodiment, the grip is teardrop shaped and having three edges defined by three ends. Two of the ends are rounded whilst the third is more pointed. Either of the rounded ends is used in conjunction with frayed ends of the bristles. It should be noted that other shaped grips may be utilized in realizing the invention. A plurality of frayed bristles extends from the edge defined by the rounded ends, opposite the pointed end. The preferable longest length of the bristle members is three-quarters an inch (0.75″). The overall width of the plurality of bristle members is preferably one-half an inch (0.5″).

The novel idea of the invention revolves around the frayed members and how they are used in training a musician a proper upstroke strumming motion The percussion plectrum gives a guitar player the ability to hold a standard guitar plectrum with a firmer grip and reduces the risk of losing the pick in the strings or producing the lour and harsh tone that is the normal result of a firm grip. When learning to play a guitar or other stringed instrument the musician must learn to properly pick the strings. For a guitar player, the pick must be maintained with a proper grip and the strings must be appropriately stroked to produce a great musical sound.

The device comprises a teardrop shaped grip having a substantially pointed end that is used for musical performances and an opposite end having bristles extending away from the grip. The ends of the bristles are frayed and preferably comprise nylon. The frayed ends can strike the strings much harder during training sessions much harder than the front end without substantially increasing the volume of the stringed instrument.

The plectrum is used by novice musicians who find playing with a standard pick difficult. It aids in learning how to play a guitar because the frayed bristles keep the edge of the plectrum correctly aligned and in the most desirable location. The desirable location of the plectrum is close to the strings but not too close which periodically causes the pick to be caught by the strings. The most desirable location is achieved by the present invention. Without the aid of the present invention, a beginner cannot ordinarily maintain the plectrum at the desirable location. The frayed ends of the bristles move up and down the strings freely while still producing a sound that id much different than a non-frayed bristle plectrum. The frayed ends produce a softer sound that does not overwhelm the tone of the pick.

By placing the frayed members at a specific point beyond the pick, as set forth herein, the novice musician may hold the pick with a firmer grip without worrying about losing the pick within the strings of the instrument or producing the dreaded sound of a pick that is struck across the strings too hard which is a sharp twang. The frayed ends extend the width and thickness of the pick such that it cannot be easily arranged within the strings. However, the musician can still strum the strings of the instrument easily because individual strands of the bristles do not interfere with the musicians play.

The frayed members provide the musician with an individualized comfort or cushion zone that is instantly recognized when playing with the plectrum. The novel design allows the musician to instantaneously adjust his or her hand position with the pick to acquire a desirable sound that many professional musicians spend years perfecting. Contact between the frayed members and the strings may be maintained during use. Moreover, the frayed ends of the bristles may be arranged at different angles to the strings during play to adjust the musician's playing position.

The frayed members of the bristles make playing the instrument easier. Should the player miss hitting the pick portion the sound will still be realistic when compared to that of the opposite end the plectrum or of a standard instrument pick. It should be recognized that the instant pick may be played backwards. That is, the musician may grasp the splayed ends of the bristles and strum the instrument strings with the grip. The splayed ends of the bristles allow the pointed edges of the grip to move more freely across the strings than traditional picks. This is an added benefit for a new musician.

The device is easy to learn and play but allows the traditional “teardrop” shape of a standard pick to remain. By arranging the rear portion with the frayed members toward the musician's hand, the opposite end can be used for standard picking/strumming. Additionally, the device may be implemented by including a second teardrop shaped pick fastened to the first which includes the frayed bristles. The second pick is arranged with its pointed edges displaced relative to the first pick as shown in FIG. 4.

Because of the “comfort zone” that the musician quickly realizes while playing the device, the opportunity to play complex rhythms are easily obtained. This allows the player to concentrate on honing the skills on their opposite hand that controls the cords that are being played.

The instant invention allows a musician better control over the volume at which the instrument is played. For instance, one can make a higher volume strike on the first note of each bar in a particular tune by using a little more of the pick edge. For the remaining notes the musician can use more of the frayed members and less of the edge of the pick obtaining a slightly lower volume. This type of playing action can only be achieved by an accomplished guitar player. Thus, the instant invention allows novice players to play like veterans.

It is important to note that the frayed members do not begin from the edge of the back of the pick but originate from the middle of the pick. This allows for additional movement of the frayed members. The closer the frayed members come to the edge of the pick, the harsher the sound produced.

It is an object of the invention to provide a plectrum that includes a first end for use in strumming the strings of an instrument in a first manner and a second end for use in automatically aligning a musician's hand to prevent the plectrum from becoming lost between the strings that are being strummed.

It is a further object of the invention to disclose a training aid that teaches a musician to properly align his or her hand during use in strumming a musical instrument.

It is another object of the invention to teach a plectrum having frayed bristles extending from one end thereof. The frayed ends attenuate the sound of the strings while preventing the plectrum from becoming dislodged from the musician's hand during use.

It is another object of the invention to provide a plectrum that provides a realistic sound from an end having frayed bristles when compared to that of the opposite end the plectrum or of a standard instrument pick.

It is a further object of the invention to provide a device that makes playing a musical instrument easier to learn and play while allows the traditional “teardrop” shape of a standard pick to remain. By arranging the rear portion with the frayed members toward the musician's hand, the opposite end can be used for standard picking/strumming.

It is another object of the invention to provide a plectrum having a novel design allows the musician to instantaneously adjust his or her hand position with the pick to acquire a desirable sound that many professional musicians spend years perfecting. Contact between the frayed members and the strings may be maintained during use. Moreover, the frayed ends of the bristles may be arranged at different angles to the strings during play to adjust the musician's playing position.

The above and further objects, details and advantages of the invention will become apparent from the following detailed description, when read in conjunction with the accompanying drawings.

### DESCRIPTION OF THE DRAWINGS

FIG. 1 is a perspective view of the present invention.

FIG. 2 is a side view of the present invention.

FIG. 3 shows the device in use.

FIG. 4 is a second embodiment of the invention and includes at least two picks fastened to one another.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

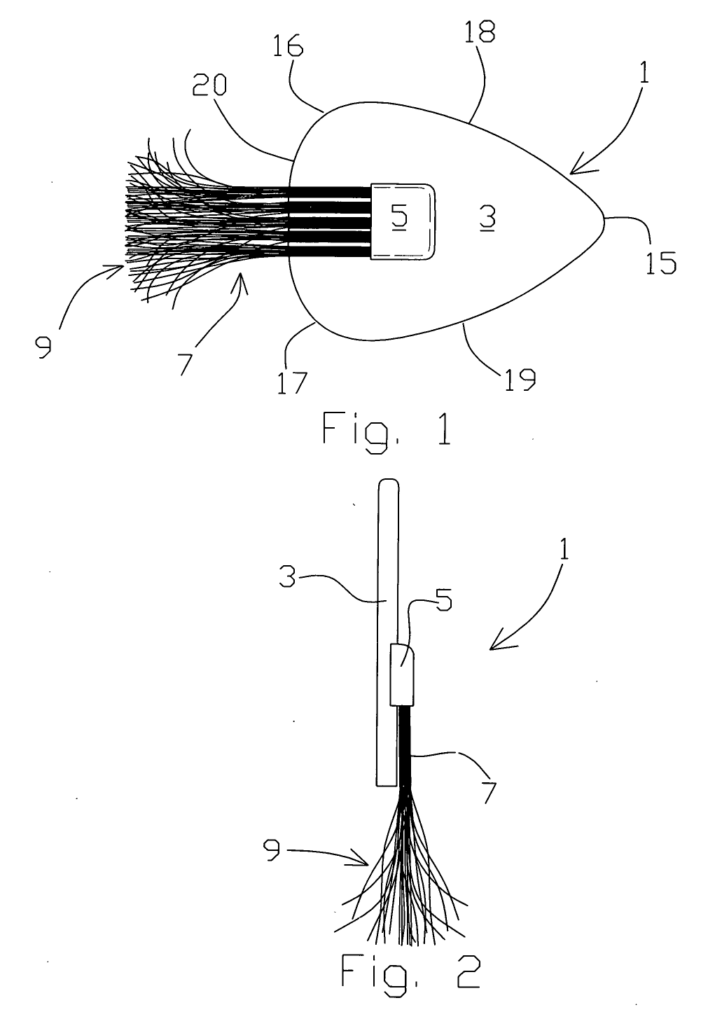

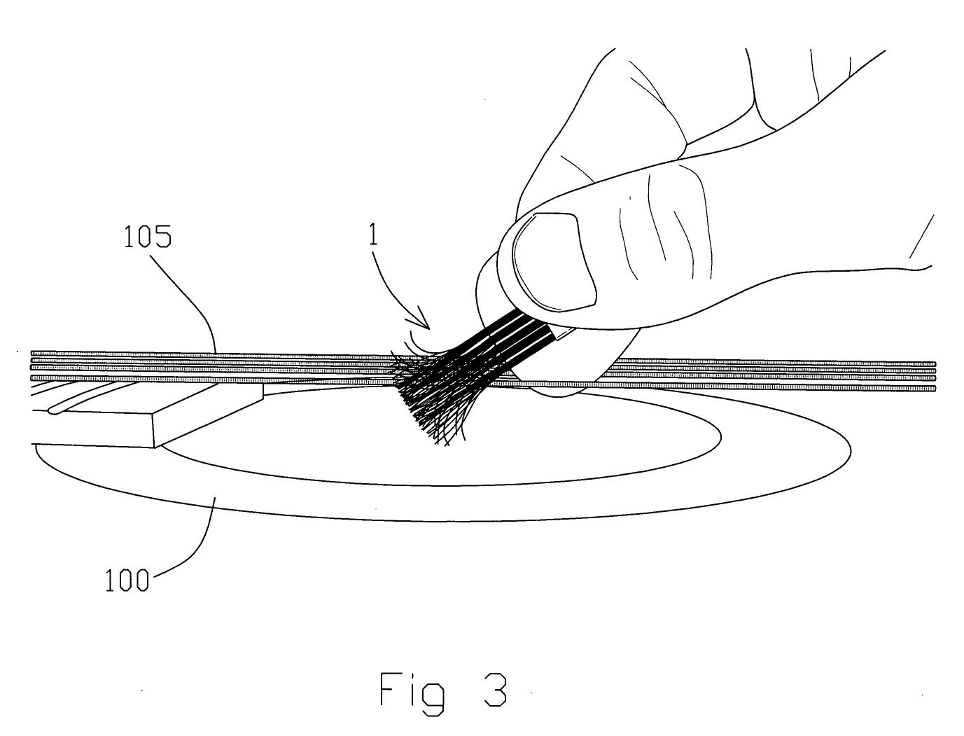

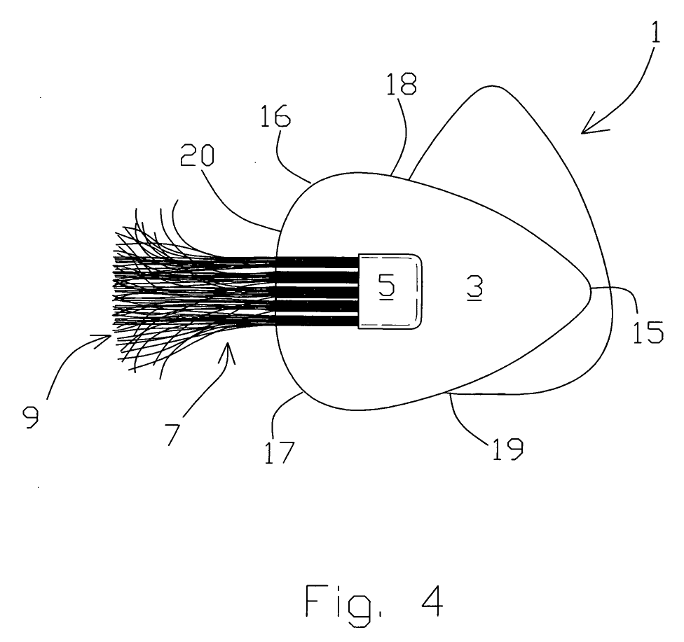

FIGS. 1 and 2 shows the device 1 that includes a grip 3 that is generally teardrop shaped and including a pointed end 15 which may be used to strum strings 105 of a stringed instrument 100. The grip 3 further includes two rounded ends 16, 17 defined by edges 18-20 as shown. A plurality of bristles 7 extend from edge 20 as shown. The plurality of bristles 7 includes frayed ends 9 which are used as shown in FIG. 3 to aid the musician in assuming a correct hand posture and maintain the pick at a correct distance in relation to the strings 105. A base of the bristles is fastened to the surface of the grip 3 via tape 5. It should be noted that glue or other fastening devices may be used in securing the bristles 7 to the grip 3.

As can be understood by viewing FIG. 3, the grip 3 is held between the finger and thumb of the musician such that one of the round ends 16. 17 is used to strum the strings. The frayed ends 9 of the bristles 7 prevent the plectrum 1 from becoming entangled in the strings 105. The plectrum 1 can be held such that the pointed end 15 engages the strings 105 to play the instrument 100.

In FIG. 4, a pair of picks are fastened atop one another with the bristles 7 extending from one of the picks. The pointed ends of each pick are displaced relative to one another such that the pointed end of one pick extends from a center of a straight edge of the other pick.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

What is claimed is:

1. An instrument to strum and pick a stringed musical instrument consisting of:
a) A grip portion that is teardrop in shape having two rounded edges representing the back of the pick; and one pointed edge representing the front of the pick and:
b) A plurality of narrow elongate bristles which are affixed to and extend from the back of the pick and are frayed at the distal tip of said bristles.

2. An instrument to strum and pick a stringed musical instrument consisting of:
a) A grip portion having two round edges and a pointed edge that extend away from the rounded edges anywhere from 90 to 25 degrees representing the back of the pick; and one pointed edge representing the front of the pick and:
b) A plurality of narrow elongate bristles which are affixed to and extend from the back of the pick and are frayed at the distal tip of said bristles.
